(19) United States
(12) Patent Application Publication
(10) Pub. No.: US 2013/0256074 A1
(43) Pub. Date: Oct. 3, 2013

(54) TURBINE ASSEMBLY HAVING IMPROVED TORQUE CAPACITY

(71) Applicants: Jason R. Walker, Pekin, IL (US); Arthur J. Bland, Peoria, IL (US)

(72) Inventors: Jason R. Walker, Pekin, IL (US); Arthur J. Bland, Peoria, IL (US)

(73) Assignee: Caterpillar Inc.

(21) Appl. No.: 13/435,579

(22) Filed: Mar. 30, 2012

(51) Int. Cl. F16H 45/00; B23P 6/00; F16D 33/18

(52) U.S. Cl. 192/3.3; 60/330; 29/402.01

(57) ABSTRACT

A turbine assembly for a torque converter includes a turbine wheel, including vanes configured to receive fluid flow and cause the turbine wheel to rotate. The turbine assembly further includes a turbine hub coupled to the turbine wheel, wherein the turbine hub is configured to transmit torque from the turbine wheel to an output shaft of the torque converter. The turbine hub and the turbine wheel are coupled to one another via a plurality of fasteners and a plurality of drive pins, such that relative circumferential displacement between the turbine hub and the turbine wheel is prevented.

### TECHNICAL FIELD

The present disclosure relates to a turbine assembly for a torque converter and, more particularly, to a turbine assembly having improved torque capacity.

### BACKGROUND

It is often desirable to provide a coupling between the rotating output of a prime mover and the rotating input of a driven load that permits a disparity between the rotational speed of the rotating output of the prime mover and the rotating input of the driven load. For example, in order to permit continuous rotation of the output of the prime mover, even when it is desirable to stop rotation of the input of the driven load, it is desirable to provide a coupling that permits the rotational output of the prime mover to continue despite the input of the driven load being stopped.

An example of such a coupling is a torque converter, which provides a hydrodynamic fluid coupling between the rotating output of a prime mover and the rotating input of a driven load. For example, a machine such as a vehicle may include an internal combustion engine and a transmission, with the output of the internal combustion engine coupled to an input of the transmission by the torque converter.

A torque converter generally includes an input coupling for coupling the output of a prime mover to the input of the torque converter, and an output shaft for coupling the output of the torque converter to a driven load, such as a transmission. The torque converter further includes a housing containing fluid, such as hydraulic fluid. Within the housing, the input coupling is coupled to a pump including an impeller for pumping the fluid in the housing. The torque converter further includes a turbine coupled to the output shaft of the torque converter. The impeller of the pump, driven by the input coupling, pumps fluid through the turbine, thereby causing the turbine to rotate and drive the output shaft of the torque converter and the input of, for example, a transmission. By virtue of the fluid coupling provided by the interaction between the impeller and the turbine, the output of the prime mover may continue to rotate the input coupling of the torque converter, even when the output shaft of the torque converter is stopped.

In some conventional torque converters, the turbine is coupled to the output shaft via a turbine hub. The turbine may be coupled to the turbine hub via a splined interface coupling, which permits the transfer of torque from the turbine to the turbine hub via the splined interface. A seal assembly may be provided in order to provide a fluid seal between fluid flowing through the turbine and a clutch assembly. Such seal assemblies may include a separate seal carrier configured to be coupled to the turbine hub and retain an elastomeric seal providing a fluid seal between the turbine and the clutch assembly.

This conventional arrangement may suffer from a number of potential drawbacks. For example, the splined interface may have a relatively limited capacity to transfer torque from the turbine to the turbine hub due to the relatively limited strength of the splines on the turbine and turbine hub. In addition, this arrangement may be undesirably complex and/or costly due to the number of parts and their associated construction. Therefore, it may be desirable to provide a turbine and/or clutch hub for a torque converter that have an improved torque transfer capacity and/or reduced complexity.

An example of a coupling between a turbine and a hub in a torque converter is described in U.S. Pat. No. 4,002,228 to Borman (“the '228 patent”). In particular, the '228 patent discloses coupling a bladed portion of the turbine to a turbine hub using a spacer member secured to the bladed portion. The bladed portion includes two annular radially inward projecting portions, which are positioned closely adjacent the outer side portions of the turbine hub and are secured to the spacer member. An opening or aperture formed in the annular portion and is alignable with an opening or aperture formed in the turbine hub. A clutch plate has a plurality of tangs, which provide a driving connection between the clutch plate and the turbine hub by engaging a shoulder formed on the turbine hub in a space disposed between the turbine hub and the spacer.

Although the '228 patent discloses a coupling between a turbine and a turbine hub, it may suffer from a number of possible drawbacks. For example, the coupling disclosed in the '228 patent permits relative circumferential rotation between the turbine and turbine hub. This may result in a reduced capacity to transfer torque and/or undue complexity of the turbine and turbine hub. The assembly and method disclosed herein may be directed to mitigating or overcoming these and other possible drawbacks.

### SUMMARY

In one aspect, the present disclosure includes a turbine assembly for a torque converter. The turbine assembly includes a turbine wheel including vanes configured to receive fluid flow and cause the turbine wheel to rotate. The turbine assembly further includes a turbine hub coupled to the turbine wheel, wherein the turbine hub is configured to transmit torque from the turbine wheel to an output shaft of the torque converter. The turbine hub and the turbine wheel are coupled to one another via a plurality of fasteners and a plurality of drive pins, such that relative circumferential displacement between the turbine hub and the turbine wheel is prevented.

In another aspect, the present disclosure includes a torque converter including a housing configured to be rotated by a prime mover, and an impeller coupled to the housing and configured to rotate with the housing and pump fluid. The torque converter further includes a turbine assembly configured to rotate as a result of fluid pumped by the impeller, and an output shaft coupled to the turbine assembly and configured to be rotated by the turbine assembly. The turbine assembly includes a turbine wheel including vanes configured to receive fluid flow and cause the turbine wheel to rotate. The turbine assembly further includes a turbine hub coupled to the turbine wheel and the output shaft, wherein the turbine hub is configured to transmit torque from the turbine wheel to the output shaft. The turbine hub and the turbine wheel are coupled to one another via a plurality of fasteners and a plurality of drive pins, such that relative circumferential displacement between the turbine hub and the turbine wheel is prevented.

In still a further aspect, the present disclosure includes a method of increasing a torque transfer capacity of a torque converter turbine assembly. The method includes securing a turbine wheel to a turbine hub via a plurality of fasteners, and providing a plurality of drive pins, each of the plurality of drive pins extending into the turbine wheel and the turbine hub. The turbine hub and the turbine wheel are secured to one another via the plurality of fasteners and the plurality of drive pins, such that relative circumferential displacement between the turbine hub and the turbine wheel is prevented.

### BRIEF DESCRIPTION OF THE DRAWINGS

FIG. 1 is a partial section view of an exemplary embodiment of a torque converter.

FIG. 2 is a partial perspective section view of a portion of the exemplary embodiment shown in FIG. 1.

### DETAILED DESCRIPTION

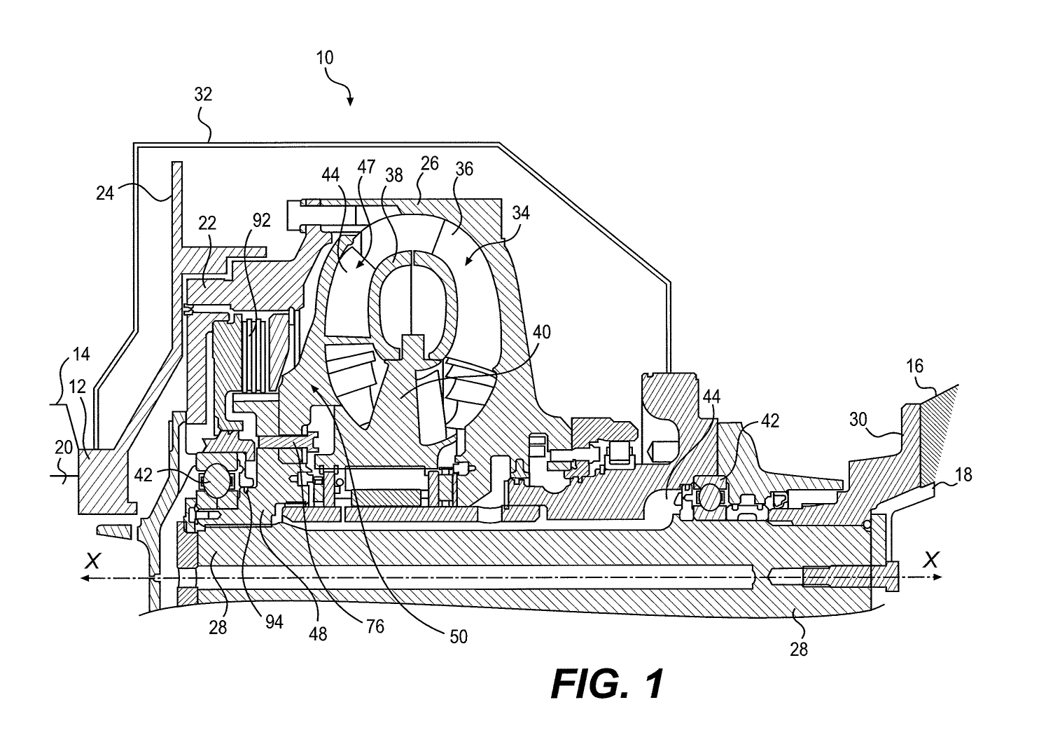

FIG. 1 is a partial section view of an exemplary embodiment of a torque converter 10 configured to couple an output 12 of a prime mover 14 to an input member 16 of a driven mechanism 18. For example, prime mover 14 may be an internal combustion engine or an electric motor having an output shaft 20 configured to be coupled to an input coupling 22 of exemplary torque converter 10. As shown in FIG. 1, for example, output shaft 20 is coupled to a flywheel 24, which, in turn, is coupled to a rotating housing 26 of exemplary torque converter 10. In the exemplary embodiment shown, flywheel 24, driven by prime mover 14, is coupled to and drives rotating housing 26. Exemplary torque converter 10 includes an output shaft 28 coupled to input member 16 of driven mechanism 18 via an output yoke 30. Driven mechanism 18 may be an input of a machine such as, for example, a transmission of a machine such as a vehicle, pump, compressor, or generator, or any other machine configured to be driven by a prime mover.

In the exemplary embodiment shown in FIG. 1, torque converter 10 includes a housing 32 configured to house the moving parts of torque converter 10, as well as fluid used to provide a fluid coupling between input member 16 and output shaft 28 of torque converter 10. Housing 32 contains rotating housing 26, which is coupled to a pump 34 having an impeller 36 configured to pump fluid within rotating housing 26. Torque converter 10 further includes a turbine 38 opposite impeller 36. Turbine 38 is coupled to output shaft 28, for example, via a splined coupling, such that as turbine 38 rotates, output shaft 28 also rotates. Exemplary torque converter 10 shown in FIG. 1 further includes a stator 40 configured to re-direct fluid exiting turbine 38 back to impeller 36 of pump 34 to improve efficiency. Output shaft 28 rotates about longitudinal axis X on a pair of bearings 42 located at opposite ends of output shaft 28, with bearings 42 being mounted in a fixed manner relative to housing 32 of torque converter 10.

During operation, prime mover 14 rotates flywheel 24, which is coupled to rotating housing 26 of torque converter 10, thereby driving rotating housing 26. Impeller 36 of pump 34, being coupled to rotating housing 26, rotates about longitudinal axis X and pumps fluid through turbine 38. Turbine 38 includes a plurality of vanes 44 configured to rotate turbine 38 about longitudinal axis X as fluid flows through vanes 44. Turbine 38, by virtue of being coupled to output shaft 28 of torque converter 10, drives output shaft 28, which is coupled to driven mechanism 18 by output yoke 30. Thus, the interaction of the fluid being pumped through turbine 38 by impeller 36 provides a hydrodynamic fluid coupling between prime mover 14 and driven mechanism 18.

The hydrodynamic fluid coupling permits output 12 of prime mover 14 to rotate at a different speed than input member 16 of driven mechanism 18. For example, for machines such as vehicles, prime mover 14 may operate at a relatively low speed while input member 16 of the transmission is held in a stopped condition (e.g., by operation of brakes of the vehicle). Pump 34 of torque converter 10 pumps fluid through turbine 38, but by holding input member 16 in a stopped condition, the energy of the pumped fluid can be absorbed by heating of the fluid rather than turning turbine 38. However, if input member is no longer held in a stopped condition, fluid pumped through turbine 38 causes it to rotate, thereby rotating output shaft 28 of torque converter 10. As the speed of output 12 of prime mover 14 is increased, pump 34 of torque converter pumps fluid through turbine 38 at an increasing rate, thereby causing turbine 38 and output shaft 28 to rotate at an increasing rate.

In the exemplary embodiment shown, output shaft 28 rotates about longitudinal axis X on bearings 42. Housing 32 includes a lubricating passage 46 configured to supply the bearing 42 located at the end of output shaft 28 adjacent output yoke 30 of torque converter 10. Lubricant may be provided under pressure to ensure sufficient lubrication and cooling of bearing 42. For example, lubricant may be supplied to bearing 42 at about 70 pounds per square inch (psi).

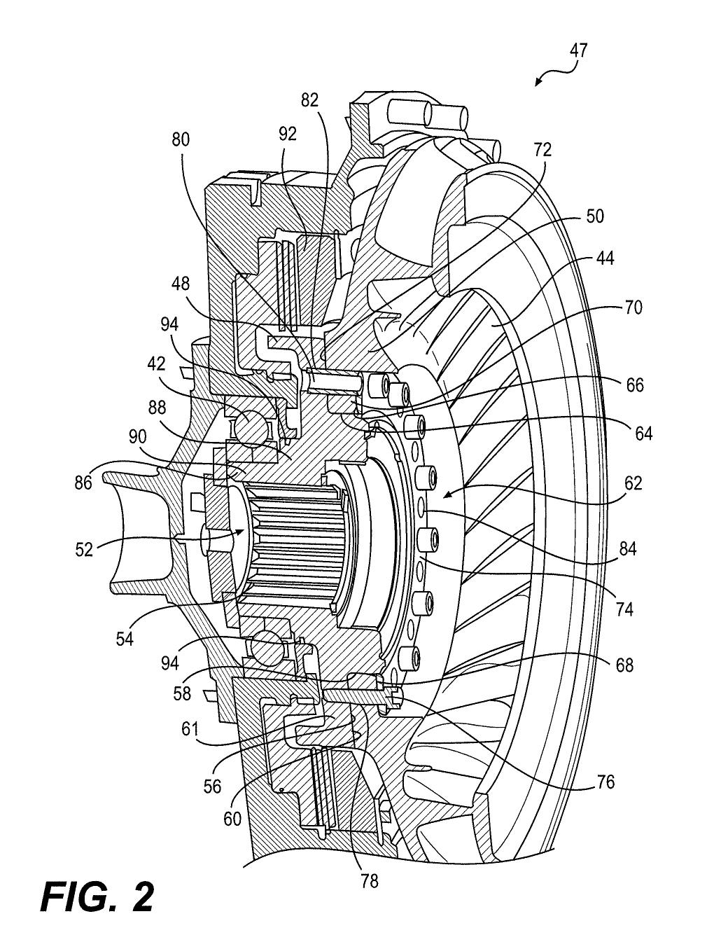

As shown in FIG. 2, exemplary turbine 38 includes a turbine assembly 47 including a turbine hub 48 and a turbine wheel 50 coupled to one another. Exemplary turbine wheel 50 includes vanes 44, which are configured to receive fluid flow from pump 34 and cause turbine wheel 50 to rotate. Exemplary turbine hub 48 is configured to transfer torque from turbine wheel 50 to output shaft 28. According to some embodiments, turbine hub 48 may be coupled to output shaft 28 via a splined coupling. For example, as shown in FIG. 2, exemplary turbine hub 48 defines an inner bore 52 provided with splines 54 configured to engage corresponding splines (not shown) on output shaft 28. When in an assembled condition, output shaft 28 is received through inner bore 52 of turbine hub 48.

As shown in FIG. 2, exemplary turbine hub 48 defines an outer annular recess 56 defining a hub shoulder 58 and a hub face 60 on a radially extending flange 61. According to some embodiments, hub face 60 defines a plane substantially perpendicular to longitudinal axis X of output shaft 28. Exemplary turbine wheel 50 has a central bore 62 defining an inner surface 64. Turbine wheel 50 also includes an inner annular recess 66 in inner surface 64 defining a first face 68 and an inwardly extending flange 70. Turbine wheel 50, on a side longitudinally opposite of first face 68, defines a second face 72. According to some embodiments, first face 68 and/or second face 72 define(s) plane(s) substantially perpendicular to longitudinal axis X of output shaft 28. Turbine wheel 50 is coupled to turbine hub 48, such that second face 72 abuts against hub face 60 of turbine hub 48, with inner surface 64 of turbine wheel 50 positioned around hub shoulder 58. According to some embodiments, turbine hub 48 may be formed of steel, although the use of other materials known in the art is contemplated. According to some embodiments, turbine wheel 50 may be at least partially formed of aluminum in order to reduce weight and/or inertia, although the use of other materials known in the art is contemplated.

In the exemplary embodiment shown in FIG. 2, turbine wheel 50 is secured to turbine hub 48 via a retaining ring 74 and a plurality of fasteners 76 (e.g., threaded fasteners having heads, such as bolts). In particular, turbine hub 48 and inwardly extending flange 70 of turbine wheel 50 include a plurality of radially spaced holes 78 configured to receive fasteners 76. According to some embodiments, holes 78 in turbine hub 48 or turbine wheel 50 may be threaded to receive threaded fasteners. According to some embodiments, fasteners 76 secure turbine hub 48 and turbine wheel 50 to one another, such that relative circumferential displacement between turbine hub 48 and turbine wheel 50 is prevented, and such that longitudinal displacement of turbine wheel 50 with respect to turbine hub 48 is prevented. In the exemplary embodiment shown in FIG. 2, retaining ring 74 is provided with holes (not shown) that correspond to holes 78 to permit fasteners 76 to extend therethrough. According to some embodiments, retaining ring 74 is positioned between the heads of fasteners 76 and serves to distribute the securing load provided by fasteners 76.

As shown in FIG. 2, second face 70 of turbine wheel 50 abuts against hub face 60 in a face-to-face relationship. As a result, fasteners 76 transfer torque between turbine wheel 50 and turbine hub 48, which, in turn, transfers torque to output shaft 28 via splines 54 of turbine hub 48 and corresponding splines on output shaft 28.

According to some embodiments, one or more drive pins 80 may be provided for enhancing the ability to transfer torque from turbine wheel 50 to turbine hub 48. Drive pins 80 prevent relative circumferential displacement between turbine hub 48 and turbine wheel 50. For example, a plurality of drive pins 80 may be received in corresponding radially spaced holes 82 in turbine hub 48 and inwardly extending flange 70 of turbine wheel 50. According to some embodiments, holes 82 may not include threading for receipt of threaded fasteners. Fasteners 76 and drive pins 80 may be spaced in a circumferentially alternating fashion, for example, such that there are any number of fasteners 76 between each drive pin 80, or such that there are any number of drive pins 80 between each fastener 76. In the exemplary embodiment shown, retaining ring 74 includes holes 84 corresponding to holes 82 configured to receive drive pins 80. According to some embodiments, retaining ring 74 may not include holes 84.

According to some embodiments, drive pins 82 may be shear pins. For example, drive pins 82 may be hollow shear pins. Hollow pins may result in reduced weight compared to solid pins and/or may provide fluid communication between converter fluid in turbine 38 and the side of turbine hub 48 opposite turbine wheel 50.

According to some embodiments, turbine hub 48 may include a cylindrical extension 86 extending from a longitudinal end of turbine hub 48 opposite outer annular recess 56. In the exemplary embodiment shown in FIG. 2, extension 86 defines a first outer cylindrical portion 88 having a first diameter, and a second outer cylindrical portion 90 having a second diameter, wherein the first diameter is greater than the second diameter. According to some embodiments, torque converter 10 may include a lock-up clutch assembly 92 configured to supplement or override the fluid coupling provided by pump 34 and turbine 38. First cylindrical portion 88 may include a seal 94 (e.g., an elastomeric seal) configured to provide a fluid seal between converter fluid from turbine 38 and clutch fluid associated with lock-up clutch assembly 92. Converter fluid may have a pressure of about 100 psi and clutch fluid may have a pressure of about 300 psi. Exemplary seal 94 may prevent fluid communication between converter fluid and clutch fluid and may serve to maintain these respective pressures. In the exemplary embodiment shown in FIG. 2, second outer cylindrical portion 90 of turbine hub 48 serves as a journal for receiving bearing 42.

In the exemplary embodiment shown in FIG. 2, first outer cylindrical portion 88, which optionally serves as a seal carrier for seal 94, is formed integrally as a single piece with the remainder of turbine hub 48. Relative to configurations having a seal carrier formed as a separate piece with respect to a turbine hub, this exemplary integral configuration may provide several benefits, such as, for example, reduced cost of manufacturing and/or reduced complexity.

### INDUSTRIAL APPLICABILITY

Exemplary turbine assembly 47 disclosed herein may provide improved torque transfer capacity. For example, some torque converters include a turbine wheel coupled to a turbine hub via engagement between complimentary splines on the turbine wheel and the turbine hub. Such an engagement may be relatively weak as a result of the lack of strength sometimes associated with splines. In addition, it may be desirable to form the turbine wheel from aluminum or other lightweight materials in order to reduce its weight and/or inertia. Splines formed of such materials may not be very strong, and thus, the torque transfer capacity of such assemblies may be correspondingly limited by the splined engagement between the turbine wheel and the turbine hub. Exemplary turbine assembly 47 may mitigate or overcome these drawbacks.

According to some embodiments, turbine assembly 47 may provide for reduced complexity and/or reduced manufacturing costs. For example, the seal carrier for providing a fluid seal between converter fluid in turbine 38 and clutch fluid associated with clutch assembly 92 is formed integrally as a single piece with turbine hub 48. This integral configuration may result in reduced manufacturing costs and/or reduced complexity relative to assemblies in which the seal carrier is separate from the turbine hub.

It will be apparent to those skilled in the art that various modifications and variations can be made to the exemplary disclosed systems, methods, and machine. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A turbine assembly for a torque converter, the turbine assembly comprising:
a turbine wheel including vanes configured to receive fluid flow and cause the turbine wheel to rotate; and
a turbine hub coupled to the turbine wheel, the turbine hub being configured to transmit torque from the turbine wheel to an output shaft of the torque converter,
wherein the turbine hub and the turbine wheel are coupled to one another via a plurality of fasteners and a plurality of drive pins, such that relative circumferential displacement between the turbine hub and the turbine wheel is prevented.

2. The turbine assembly of claim 1, wherein the turbine wheel and the turbine hub are configured to rotate about a longitudinal axis, and at least one of the fasteners and the drive pins extend in a direction substantially parallel to the longitudinal axis.

3. The turbine assembly of claim 1, wherein the drive pins are hollow and provide fluid communication between one side the of turbine wheel and a side of the turbine hub opposite the turbine wheel.

4. The turbine assembly of claim 1, wherein the turbine hub includes a cylindrical extension on a side of the turbine hub opposite the turbine wheel, and a seal retained on the cylindrical extension.

5. The turbine assembly of claim 4, wherein the seal is configured to prevent flow communication between fluid in the turbine wheel and fluid in a clutch assembly of the torque converter.

6. The turbine assembly of claim 4, wherein the cylindrical extension is integrally formed as a single piece with the turbine hub.

7. The turbine assembly of claim 4, wherein the cylindrical extension defines a journal configured to receive a bearing configured to rotatably support the output shaft of the torque converter.

8. The turbine assembly of claim 1, further including a retaining ring between heads of the fasteners and the turbine wheel, the retaining ring being configured to distribute a securing load provided by the fasteners.

9. The turbine assembly of claim 1, wherein the turbine hub defines a bore having a plurality of splines configured to transmit torque to the output shaft of the torque converter.

10. A torque converter comprising:
a housing configured to be rotated by a prime mover;
an impeller coupled to the housing and configured to rotate with the housing and pump fluid;
a turbine assembly configured to rotate as a result of fluid pumped by the impeller; and
an output shaft coupled to the turbine assembly and configured to be rotated by the turbine assembly,
wherein the turbine assembly includes:
a turbine wheel including vanes configured to receive fluid flow and cause the turbine wheel to rotate; and
a turbine hub coupled to the turbine wheel and the output shaft, the turbine hub being configured to transmit torque from the turbine wheel to the output shaft,
wherein the turbine hub and the turbine wheel are coupled to one another via a plurality of fasteners and a plurality of drive pins, such that relative circumferential displacement between the turbine hub and the turbine wheel is prevented.

11. The torque converter of claim 10, wherein the turbine wheel and the turbine hub are configured to rotate about a longitudinal axis of the output shaft, and at least one of the fasteners and the drive pins extend in a direction substantially parallel to the longitudinal axis.

12. The torque converter of claim 10, wherein the drive pins are hollow and provide fluid communication between one side the of turbine wheel and a side of the turbine hub opposite the turbine wheel.

13. The torque converter of claim 10, wherein the turbine hub includes a cylindrical extension on a side of the turbine hub opposite the turbine wheel, and a seal retained on the cylindrical extension.

14. The torque converter of claim 13, further including a clutch assembly configured to be activated by clutch fluid, wherein the turbine assembly is configured to contain converter fluid, and the seal is configured to prevent flow communication between the converter fluid and the clutch fluid.

15. The torque converter of claim 13, wherein the cylindrical extension is integrally formed as a single piece with the turbine hub.

16. The torque converter of claim 13, wherein the cylindrical extension defines a journal receiving a bearing configured to rotatably support the output shaft.

17. The torque converter of claim 10, further including a retaining ring between heads of the fasteners and the turbine wheel, the retaining ring being configured to distribute a securing load provided by the fasteners.

18. The torque converter of claim 10, wherein the turbine hub defines a bore having a plurality of splines configured transmit torque to the output shaft of the torque converter.

19. A method of increasing a torque transfer capacity of a torque converter turbine assembly, the method comprising:
securing a turbine wheel to a turbine hub via a plurality of fasteners; and
providing a plurality of drive pins, each of the plurality of drive pins extending into the turbine wheel and the turbine hub,
wherein the turbine hub and the turbine wheel are secured to one another via the plurality of fasteners and the plurality of drive pins, such that relative circumferential displacement between the turbine hub and the turbine wheel is prevented.

20. The method of claim 19, wherein the fasteners are threaded fasteners, and the drive pins are hollow.
